(19) United States
(12) Patent Application Publication
(10) Pub. No.: US 2004/0048954 A1
(43) Pub. Date: Mar. 11, 2004

(54) Pigment stabilizer for epoxy coatings and method of pigment stabilization

(75) Inventor: Lawrence E. Thieben, Waterville, OH (US)

Correspondence Address: BASF CORPORATION, ANNE GERRY SABOURIN, 26701 TELEGRAPH ROAD, SOUTHFIELD, MI, 48034-2442, US

(73) Assignee: BASF CORPORATION, Mount Olive, NJ

(21) Appl. No.: 10/065,012

(22) Filed: Sep. 10, 2002

(51) Int. Cl. C08L 63/00

(52) U.S. Cl. 523/458

(57) ABSTRACT

The present invention is a pigmented coating composition, including a film-forming polymer comprising an epoxide polymer. The coating contains a mixture of crosslinking agents wherein at least one crosslinking agent is a polyamide functional compound and at least one crosslinking agent is a phenalkamine compound. The mixture of crosslinking agents is useful in stabilizing the pigment in the coating composition.

### BACKGROUND OF INVENTION

As used herein, “automotive refinish”refers to compositions and processes used in the repair of a damaged automotive finish, usually an OEM provided finish. Refinish operations may involve the repair of one or more outer coating layers, the repair or replacement of entire automotive body components, or a combination of both. The terms “refinish coating”or “repair coating” may be used interchangeably.

Refinish compositions comprise a principal resin and a crosslinking or hardener resin. Generally such coatings cure at ambient or only slightly elevated temperatures, generally at temperatures below 140° F. Because curing occurs at lower temperatures, it is desirable to balance the properties of dry time, also referred to as dry to handle time, (i.e. the time it takes until the surface is no longer tacky), with the pot life or storage stability of the coating. It is desirable to provide rapid dry time and it is also desirable to prolong shelf life.

Coating compositions comprising epoxy ether and/or epoxy ester type resin compositions and utilizing amine hardeners are known in the art. Coating compositions utilizing phenalkamine as the amine hardener or crosslinker are known in the art. U.S. Pat. No. 6,262,148 teaches phenalkamine curing agents and coatings comprising epoxy resin compositions and phenalkamine curing agents. The coating contains titanium dioxide and is cured overnight at 22° C. U.S. Pat. No. 6,376,579 teaches a cement primer coating containing a gray color concentrate and utilizing the phenalkamine curing agent and a tertiary amine accelerator to promote low temperature cure at below 0° C.

Phenalkamine curing agents are Mannich base compounds that are the reaction product of an aldehyde, an amine and a phenolic compound. Coatings comprising a phenalkamine resin and epoxy resin cure quickly, but have the disadvantage that various pigments, particularly anticorrosive pigments settle out of the coating composition. Various coating operations, particularly refinish coating operations, do not employ mixers due to equipment and time constraints at the point of coating application. Therefore coatings comprising the phenalkamine hardener alone are inadequate for refinish use because the pigment settles out of the coating.

Experimentation with various types of pigments did not solve the pigment-settling problem. It has unexpectedly been found that a combination of an additional hardener in the form of an amide with the phenalkamine resulted in a coating having a stable dispersion of ingredients with no settling of pigments.

### SUMMARY OF INVENTION

The present invention is a pigmented coating composition, including a film-forming polymer comprising an epoxide polymer having an equivalent weight between 170 and 900. The coating contains a mixture of crosslinking agents wherein at least one crosslinking agent is a polyamide functional compound and at least one crosslinking agent is a phenalkamine compound. The crosslinker mixture contributes to stabilizing the pigment component in the coating.

### DETAILED DESCRIPTION

The present invention is an ambient cure, coating composition, including a film-forming polymer comprising an epoxide polymer having an equivalent weight between 170 and 900. Useful epoxides can be prepared from alcohols, e.g., butanol, trimethylol propane, by reaction with an epihalohydrin (e.g., epichlorohydrin), or by reaction of an allyl group with peroxide. Oligomeric or polymeric polyepoxides, such as acrylic polymers or oligomers containing glycidyl methacrylate or epoxy-terminated polyglycidyl ethers such as the diglycidyl ether of bisphenol A (DGEBPA), can also be used. Epoxidized polyurethane resins or polyester resins can be prepared by reacting OH group-containing polyurethanes or polyesters, as are known in the art, with an epihalohydrin. Epoxides can also be prepared by reacting an isocyanate-terminated component such as a monomeric polyisocyanate or polymer or oligomer with glycidol. Other known polyepoxides, e.g., epoxy-novolacs, may also be used. Useful commercial epoxy resins based on epichlorohydrin-bisphenol A and having an epoxy equivalent weight of between 675 and 820, for the present invention include D.E.R. 660-MAK80 and D.E.R660-PA80 available from Dow Chemical and The glycidyl ether type epoxy resins described above include, for example, epoxy resins having a glycidyl ether group which can be obtained by reacting polyhydric alcohols and polyhydric phenols with epihalohydrin or alkylene oxides. Examples of the polyhydric alcohols described above include divalent alcohols such as ethylene glycol, polyethylene glycol, propylene glycol polypropylene glycol, neopentyl glycol, butylene glycol and hexanediol; trivalent alcohols such as glycerin, trimethylolethane and trimethylolpropane; pentaerythritol, diglycerin and sorbitol. Examples of the polyhydric phenols described above include 2,2-bis(4-hydroxyphenyl)propane-[bisphenol A], 2,2-bis(2-hydroxyphenyl)propane, 2-(2-hydroxyphenyl)-2-(4-hydroxyphenyl)propane, halogenated bisphenol A, bis(4-hydroxy-phenyl)methane [bisphenol F], tris(4-hydroxyphenyl)propane, resorcin, tetrahydroxyphenylethane, 1,2,3-tris(2,3-epoxypropoxy)-propane, novolak type polyhydric phenols and cresol type polyhydric phenols.

Coatings containing the glycidyl ester type epoxy resins did not require pigment stabilization and were not utilized in the present invention.

The coating contains a mixture of crosslinking agents wherein at least one crosslinking agent is a phenalkamine and at least one crosslinking agent is a polyamide compound. The phenalkamine compound is a Mannich base compound that is the reaction product of an aldehyde, such as formaldehyde, amine, and a phenolic compound. Useful amines used to form the phenalkamine include ethylenediamine and diethyltriamine. The phenolic compound is a cardanol-containing extract derived from cashew nutshell liquid. The phenalkamine provides rapid cure and good chemical resistance and cures at temperatures as low as 32-35° F. The phenalkamines have an amine value of between 120 and 165 mg KOH/gm resin and a viscosity at 25° C. of between 1000 and 3500 cPs. The phenalkamine has a weight average molecular weight of between 700 and 900. The preferred phenalkamines are available as Cardolite® Lite 2562 from Cardolite Corporation. The Cardolite Lite 2562 has a polymodal distribution of species with a number average composite molecular weight of about 540 and a number average molecular weight of about 866.

When used alone, the phenalkamine result in settling of pigment from the coating composition. Pigment settling was observed within ½ hour of the addition of the phenalkamine. It is hypothesized that the polar groups on the pigments utilized in the instant invention interact with the phenalkamine to cause the pigment to settle out of the coating composition. It was surprisingly observed that the addition of polyamide to the coating in combination with the phenalkamine resulted in a stable coating with little or no settling of pigment therein.

The polyamide curing agent utilized in combination with the phenalkamine is based on the reaction product of dimerized fatty acid with polyamine, preferably, difunctional polyamines. The amide may be derived from aliphatic polyamines such as ethylenediamine, propylenediamine, butylenediamine, hexamethylenediamine; alicyclic polyamines such as 1,3-bis-aminomethylcyclohexane and isophoronediamine; aromatic polyamines such as xylilenediamine, metaxylenediamine, diaminodiphenylmethane and phenylenediamine. Preferably the amides are formed by a condensation reaction. The polyamide may be used in solid form, such as a wax or liquid form.

The polyamide resin preferably has an amine value of 159-175 mg KOH/gm resin. The polyamides have a long pot life and good adhesion. Suitable polyamide compositions include those sold under the trademarks Versamid®, available from Cognis Corp. USA of Cincinnati, Ohio, and Ancamine 2353, available from Air Products.

The polyamide and phenalkamine crosslinkers are used in a mixture comprising phenalkamine compound present in an amount between 98% and 2% by weight and polyamide functional compound present in an amount between 2% and 98% by weight, based on total crosslinker weight. A stabilizing effect on the coating, where pigment settling is minimized is seen with as little as 2% of the polyamide. More preferably, the stabilizing effect is seen with at least 5% polyamide and even more preferably with 10% polyamide. All percentages are based on total crosslinking composition weight. A higher percentage of phenalkamine results in a faster dry time for the coating. For optimal dry time and coating stability the crosslinker comprises a mixture of at least 50% phenalkylamine. Most preferably, for an optimal balance of dry time and coating stability, the mixture comprises phenalkamine compound present in an amount between 60 and 40% by weight and the polyamide functional compound is present in an amount between 40% and 60% by weight based on total crosslinker weight.

The coating further comprises one or more pigments, particularly anti-corrosive pigments. These include, metal oxide pigments, titanium dioxide, talcum, calcium carbonate, calcium metasilicate, calcium phosphate, calcium molybdate, calcium metaborate, barium sulfate, barium metaborate, zinc phosphate, zinc chromate, zinc nitrophthalate, zinc molybdate, zinc benzoate, aluminum zinc phosphate and aluminum triphosphate and mixtures thereof.

Most preferably the pigment is selected from the group consisting of zinc oxide, titanium dioxide, iron oxide, talcum, calcium carbonate, calcium metasilicate, barium sulfate, zinc phosphate, zinc chromate, calcium phosphate, barium metaborate and mixtures thereof. The pigment is utilized in an amount between 32 and 52% by weight, based on total non-volatile weight of the coating composition.

The coating composition further includes organic solvent. Solvent is generally present in an amount between 27 and 46% by weight, based on total coating composition weight. Any organic solvents can be used in the instant coating composition without specific restrictions as long as they can dissolve or disperse the above epoxy resin and curing agents. Specific examples of the organic solvent include, for example, hydrocarbon base solvents such as xylene, toluene, VM & P naphtha, mineral spirit, solvent kerosene, aromatic naphtha, solvent naphtha, Solvesso 100, Solvesso 150 and Solvesso 200 (“Solvesso” is the registered trade name of Esso Oil Co., Ltd.), Swasol 310, Swasol 1000 and Swasol 1500 (“Swasol” is the registered trade name of Cosmo Oil Co., Ltd.), n-butane, n-hexane, n-heptane, n-octane, isononane, n-decane, n-dodecane, cyclopentane, cyclohexane and cyclobutane. Additional solvents include ketones such as acetone, methyl ethyl ketone, methyl isobutyl ketone, cylohexanone and isophorone. Ester base solvents such as ethyl acetate, butyl acetate, ethylene glycol monomethyl ether acetate, ethylene glycol monoethyl ether acetate and diethyl succinate may be utilized. Additionally, ether alcohol base solvents such as ethylene glycol monoethyl ether, ethylene glycol monobutyl ether and diethylene glycol monoethyl ether; and alcohol base solvents such as ethanol, isopropanol, n-butanol and isobutanol are useful. Any of these organic solvents can be used alone or in a mixture of two or more kinds thereof.

Additives, such as catalysts, pigments, dyes, fillers, flow control agents, dispersants, adhesion promoters, thixotropic agents, and the like may be added as required to the coating compositions of the invention.

The coating compositions of the invention may be stored as such for prolonged periods at room temperature without gel formation or undesirable changes. They may be diluted as required to a suitable concentration and applied by conventional methods, for example, spraying or spread coating, and cured by exposure to ambient temperatures of from 70 to 75° F. for a period of from 1 to 3 hours, preferably from 1.5 to 2 hours. The coating is preferably cured at temperatures above 20° F. (−6° C.) and below 140° F. (60° C.) and more preferably at temperatures above 32° F. (0° C.) and below 120° F. (41° C.), most preferably at temperatures above 40° F. (4° C.) and below 100° F. (41° C.).

The coating is further described in the following non-limiting examples.

1. A coating composition comprising
a film-forming polymer comprising an epoxide polymer having an equivalent weight between 170 and 900,
a mixture of crosslinking agents wherein at least one crosslinking agent is a polyamide functional compound and at least one crosslinking agent is a phenalkamine compound, and
one or more pigments.

2. A coating composition according to claim 1, wherein the epoxide polymer comprises an epoxy-terminated polyglycidyl ether of bisphenol A.

3. A coating composition according to claim 1 wherein the crosslinking agents comprise a mixture of phenalkamine compound and polyamide functional compound where phenalkamine compound is present in an amount between 98% and 2% by weight and the polyamide functional compound is present in an amount between 2% and 98% by weight based on total crosslinker weight.

4. A coating composition according to claim 1, wherein the crosslinking agents comprise a mixture of phenalkamine compound and polyamide functional compound where phenalkamine compound is present in an amount between 40 and 98% by weight and the polyamide functional compound is present in an amount between 2% and 60% by weight based on total crosslinker weight.

5. A coating composition according to claim 1, wherein the crosslinking agents comprise a mixture of phenalkamine compound and polyamide functional compound where phenalkamine compound is present in an amount between 50% and 98% by weight and the polyamide functional compound is present in an amount between 2% and 50% by weight based on total crosslinker weight.

6. A coating composition according to claim 1 wherein the crosslinking agents comprise a mixture of phenalkamine compound and polyamide functional compound where phenalkamine compound is present in an amount between 60 and 40% by weight and the polyamide functional compound is present in an amount between 40% and 60% by weight based on total crosslinker weight.

7. A coating composition according to claim 1 wherein the pigment is selected from the group consisting of metal oxide pigments, titanium dioxide, talcum, calcium carbonate, calcium metasilicate, calcium phosphate, calcium molybdate, calcium metaborate, barium sulfate, barium metaborate, zinc phosphate, zinc chromate, zinc nitrophthalate, zinc molybdate, zinc benzoate, aluminum zinc phosphate and aluminum triphosphate and mixtures thereof.

8. A coating composition according to claim 1 wherein the pigment is selected from the group consisting of zinc oxide pigments, titanium dioxide, iron oxide, talcum, calcium carbonate, calcium metasilicate, barium sulfate, zinc phosphate, zinc chromate, calcium phosphate, barium metaborate and mixtures thereof.

9. A coating composition according to claim 11 wherein the phenalkamine compound is present in an amount between 40% and 98% by weight and the polyamide compound is present in an amount between 60% and 2% by weight, where weight is based on total crosslinker weight.

10. A coating composition according to claim 1 wherein the pigment is present in an amount between 32 and 52% by weight, based on total solids weight of the coating composition.

11. A coating composition according to claim 1 wherein the coating is cured at ambient temperature.

12. A coating composition according to claim 1, wherein the coating comprises a primer coating for automotive refinish applications.

13. A method of forming a stable dispersion of pigment in a coating composition comprising combining
a film-forming polymer comprising an epoxide polymer having an equivalent weight between 170 and 900,
a mixture of crosslinking agents wherein at least one crosslinking agent is a polyamide functional compound and at least one crosslinking agent is a phenalkamine compound, and
one or more pigments.

14. A method according to claim 13 wherein the epoxide polymer comprises an epoxy-terminated polyglycidyl ether of bisphenol A.

15. A method according to claim 1 3, wherein the crosslinking agents comprise a mixture of phenalkamine compound and polyamide functional compound where phenalkamine compound is present in an amount between 98% and 2% by weight and the polyamide functional compound is present in an amount between 2% and 98% by weight based on total crosslinker weight.

16. A method according to claim 13, wherein the crosslinking agents comprise a mixture of phenalkamine compound and polyamide functional compound where phenalkamine compound is present in an amount between 40 and 98% by weight and the polyamide functional compound is present in an amount between 2% and 60% by weight based on total crosslinker weight.

17. A method according to claim 1 3, wherein the crosslinking agents comprising a mixture of phenalkamine compound and polyamide functional compound where phenalkamine compound is present in an amount between 50% and 98% by weight and the polyamide functional compound is present in an amount between 2% and 50% by weight based on total crosslinker weight.

18. A method according to claim 13, wherein the crosslinking agents comprise a mixture of phenalkamine compound and polyamide functional compound where phenalkamine compound is present in an amount between 60 and 40% by weight and the polyamide functional compound is present in an amount between 40% and 60% by weight based on total crosslinker weight.

19. A method according to claim 1 3, wherein the pigment is selected from the group consisting of metal oxide pigments, titanium dioxide, talcum, calcium carbonate, calcium metasilicate, calcium phosphate, calcium molybdate, calcium metaborate, barium sulfate, barium metaborate, zinc phosphate, zinc chromate, zinc nitrophthalate, zinc molybdate, zinc benzoate, aluminum zinc phosphate and aluminum triphosphate and mixtures thereof.

20. A method according to claim 13, wherein the pigment is selected from the group consisting of zinc oxide pigments, titanium dioxide, iron oxide, talcum, calcium carbonate, calcium metasilicate, barium sulfate, zinc phosphate, zinc chromate, calcium phosphate, barium metaborate and mixtures thereof.

21. A method according to claim 19, wherein the phenalkamine compound is present in an amount between 40% and 98% by weight and the polyamide crosslinker is present in an amount between 60% and 2% by weight, based on total crosslinker weight.
